(19) United States
(12) Patent Application Publication
(10) Pub. No.: US 2013/0297075 A1
(43) Pub. Date: Nov. 7, 2013

(54) CONTROL SYSTEM

(71) Applicant: TRANE INTERNATIONAL, INC., Piscataway, NJ (US)

(72) Inventor: Joseph George Land, III, Tyler, TX (US)

(21) Appl. No.: 13/888,953

(22) Filed: May 7, 2013

Related U.S. Application Data
(60) Provisional application No. 61/643,704, filed on May 7, 2012.

(51) Int. Cl. G05B 15/02

(52) U.S. Cl. CPC G05B 15/02
USPC 700/275

(57) ABSTRACT

Spaces in a building may be classified into one or more classifications. Rules for managing devices in the spaces may be established. A property manager and a tenant or owner may control the settings of the devices via a controller. The controller may adjust the settings of the devices with accordance with the rules.

### CROSS-REFERENCE TO RELATED APPLICATIONS

The present application claims the benefit of U.S. Provisional Patent Application No. 61/643,704, filed on May 7, 2012, which is hereby incorporated by reference in its entirety.

### BACKGROUND

The present invention generally relates to control systems for buildings, and more particularly, but not exclusively, relates to multi-occupancy building control systems.

Sensors and control actuators may perform different functions in buildings. Some existing building control systems have various shortcomings relative to certain multi-occupancy applications. Accordingly, there remains a need for further contributions in this area.

### SUMMARY

One embodiment of the present invention is a multi-occupancy building control system. Other embodiments include apparatuses and methods for building control systems. Further embodiments of the present invention will become apparent from the description and figures that follow.

### BRIEF DESCRIPTION OF THE FIGURES

The description herein makes reference to the accompanying figures wherein like reference numerals refer to like parts throughout the several views, and wherein:

FIG. 1 is a schematic diagram of a control system.

FIG. 2 is a schematic diagram of a control system computer.

FIG. 3 is a schematic diagram of sensors and/or actuators for a control system.

FIG. 4 is a schematic diagram of a control system.

### DETAILED DESCRIPTION OF THE ILLUSTRATIVE EMBODIMENTS

For the purposes of promoting an understanding of the principles of the present invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

The present application relates to a system that allows property managers to monitor and/or manage common space, unoccupied units, and impose certain restrictions or settings on occupied units while tenants or owners of occupied units have private control over certain elements and restricted control over other elements.

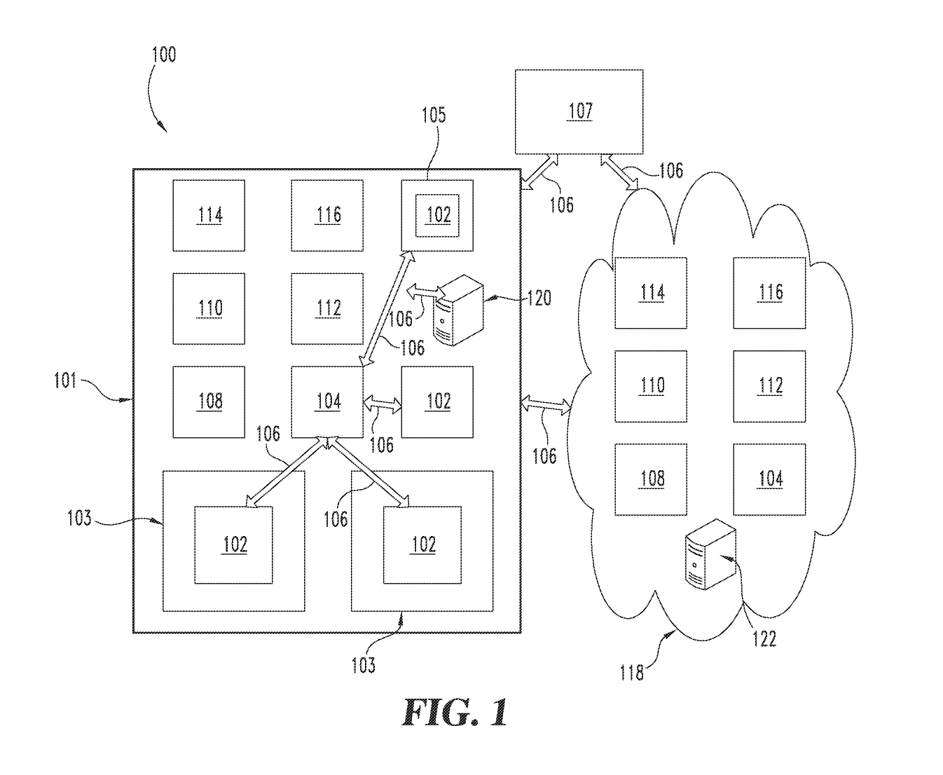

FIG. 1 is a schematic diagram of a system 100 for providing control over various sensors and actuators in a building 101. The system 100 includes one or more sensors/actuators 102 that measure and/or regulate various parameters in the building 101. The sensors/actuators 102 may be in various spaces in the building 101 such as in housing units 103 or in common areas 105. The building 101 may include one or more different types of housing units 103 such as a hotel, an apartment complex, a condominium building, a storage garage, a dormitory, an assisted living facility, a nursing home, a retirement home, a commercial office building, and/or any other building with housing units that may be occupied by a person or property. For example, in the case of a storage garage, the housing unit 103 would typically be occupied by property. As another example, a person would occupy a housing unit 103 in a commercial office building to work in, but typically not to live in.

As yet another example, in the case of an assisted living facility, a nursing home, or a retirement home, a family member may use the remote access features described below rather than the occupant. The family member may use the system 100 to see if an elderly relative unlocked the door and left the housing unit 103, for example.

The system 100 further includes a master control device 104 that collects incoming data, sends command signals, and sends requests for data based on a defined set of rules. It is contemplated that the defined set of rules may be changed as discussed below. For example, the master control device 104 controls whether certain changes to the settings may be made by a property manager or tenant/owner (e.g., an individual renting a housing unit, an individual leasing a housing unit, an individual owning a housing unit such as a condominium, or the like) based on the classes and rules established for the sensors/actuators 102. The rule(s) may be set per sensor or actuator. It is contemplated that there may be more than one master control device 104 in the system 100 such that there may be a master control device 104 in each housing unit 103 or common area 105 to control the sensors/actuators 102 for that housing unit 103 or common area 105. Furthermore, it is contemplated that there may be multiple master control devices 104, there is not a master control device 104 in each housing unit 103 or common area 105. In some embodiments, when there are multiple master control devices 104, the master control devices 104 may be grouped together.

The system 100 includes a communication channel 106 for transferring information (either one-way or bi-directionally) from the sensors/actuators 102 to the master control device 104. The communication channel 106 for transferring information may include a Z-Wave wireless mesh network, a Zigbee wireless mesh network, an 802.11 wireless network, TCP/IP over Ethernet, a proprietary radio protocol, a proprietary wired communication protocol, the Trane Comfort Link II wired communication protocol, the Internet, NFC, Bluetooth, or any other suitable communication channel. Moreover, the sensors/actuators 102 include appropriate circuitry and/or firmware/software that allows the sensors/actuators 102 to utilize the communication channel 106 to communicate with the master control device 104 wirelessly or by a wired connection. In addition, the sensors/actuators 102 may communicate with the cloud service 118 over the Internet or any other communication channel to receive settings.

The system 100 may also include a classification module 108 for registering or classifying the sensors/actuators 102 into a hierarchy of access rights and managing rule sets for transferring sets of registered sensors/actuators 102 among access sets. For example, the classification module 108 may include a property master account that includes different classes of control rights such as common area (management controlled), unoccupied unit (management controlled), occupied unit—restricted control (tenant/owner controlled within boundary rules established by management), and occupied unit (e.g., an individual is living in the unit in the case of an apartment or condominium or dormitory, an individual is staying in the unit temporarily as in the case of a hotel, property is in the unit in the case of a storage garage)—full control (tenant/owner has lull control of the sensors/actuators 102).

Another example is a tenant/owner account that may include one of the following classes: occupied unit with restricted control (tenant/owner controlled within boundary rules established by management), and occupied unit with full control (tenant/owner has full control of the sensors/actuators 102). Accordingly, there may be a first hierarchy of rules for the property manager and a second hierarchy of rules for the tenant/owner in which the first hierarchy of rules establishes boundaries for the second hierarchy of rules. It is contemplated that in a hierarchy there may be one rule or multiple rules.

The classification may be based on any type of information including but not limited to occupancy of the unit, location (common area v. housing unit), or ownership of the unit (not own (e.g., rent, lease, etc.) v. own). Other accounts and classifications are contemplated. Based on the classification of the space (e.g., housing unit 103 or common area 105, occupancy, or ownership), the property manager and/or tenant/owner may adjust the settings of the sensors/actuators 102 within the boundaries defined by the rules.

The system 100 includes a property manager module 110 that allows property managers to monitor and/or control assigned devices individually, in groups, and/or in aggregate through a user interface The property manager module 110 communicates with the master control device 104 to monitor and/or control the sensors/actuators 102. The system 100 includes a tenant/owner module 112 that allows tenants/owners to monitor and/or control assigned devices through a user interface. The property manager module 110 communicates with the master control device 104 to monitor and/or control the sensors/actuators 102.

The system 100 includes a transfer module 114 for deciding and/or managing the transfer of control from tenants/owners to property mangers when units become unoccupied or from property managers to tenants/owners when units become occupied. For example, when a housing unit 103 becomes unoccupied, the property manager may receive greater rights to control the settings of the sensors/actuators 102 of the unoccupied housing unit 103. The transfer module 114 may change the classification and/or rules associated with the sensors/actuators 102 in the unoccupied housing unit 103 to reflect that the property manager has more control over the settings of those sensors/actuators 102. As another example, when a housing unit 103 becomes occupied, the tenant/owner may receive greater rights to control the settings of the sensors/actuators 102 of the occupied housing unit 103. The transfer module 114 may change the classification and/or rules associated with the sensors/actuators 102 in the occupied housing unit 103 to reflect that the tenant/owner has more control over the settings of those sensors/actuators 102.

The system 100 may include a rules module 116 that allows property managers to establish boundary rules for each of the classifications in the classification module 108 for tenant/owner control of certain sensors/actuators 102. For example, a property manager may set the maximum and minimum allowable thermostat set points or set rules that require certain exterior lights to be on or off at certain times of the day. As another example, a property manager may allow a tenant/owner to use certain cameras or motion sensors such as ones in or around the tenant/owner's particular housing unit 103. As another example, the property manager may maintain control over certain sensors/actuators 102 that are in common areas such as irrigation controls and pool controls. In yet another example, a property manager may allow the tenant/owner to program a certain number credentials into a door lock 302 on the tenant/owner's housing unit 103. The rules module 116 may also establish the boundary rule or settings for sensors/actuators 102 in common areas 105.

The master control device 104 may receive commands from the property manager module 110 and/or tenant/owner module 112 related to configuring settings or monitoring settings for one or more of the sensors/actuators 102. The master control device 104 will determine whether the property manager module 110 and/or tenant/owner module 112 has sufficient rights to make those changes to the settings by inquiring the classification module 108 to determine the classification and control rights for those sensors/actuators 102. If the property manager module 110 and/or tenant/owner module 112 does have sufficient rights, then the master control device 104 will implement those changes to the settings in the sensors/actuators 102. if the property manager module 110 and/or tenant/owner module 112 does not have sufficient rights, then the master control device 104 will not implement those changes to the settings in the sensors/actuators 102.

One or more of the modules including the classification module 108, the property manager module 110, the tenant/owner module 112, the transfer module 114, and the rules module 116 may each be part of a cloud service 118 or one or more computers or servers 120 at the building 101. A property manager or tenant/owner may use a computer, handheld device (e.g., a smartphone, a tablet computer), or the like to access one or more of the modules 108, 110, 112, 114, 116 over a network such as LAN, WAN, or the Internet to set up rules or configure one or more of the sensors/actuators 102. It is also contemplated that one or more of the modules 108, 110, 112, 114, 116 may be included in mobile device 107 (e.g., smartphone, tablet computer) in which case the mobile device 107 is configured to communicate with the master control device 104, the computer 120, and/or server 122 using an appropriate communication protocol.

The master control device 104 may also be part of the cloud service 118 in which case the sensors/actuators 102 communicate over the Internet or any other communication channel 106 with the cloud service 118. In one example, some of the sensors/actuators 102, such as a reader, may include a reader interface, which is responsible for the communication between sensors/actuators 102 and the master control device 104.

The cloud service 118 provides various services for controlling and managing the sensors/actuators 102. The cloud service 118 may include a server and a database 122 to store unit classification information, control rules, unit classifications, sensor/actuator settings, among other settings. Moreover, as described above, the cloud service may include one or more modules such as the classification module 108, the property manager module 110, the tenant/owner module 112, the transfer module 114, and the rules module 116. The cloud service 118 allows property managers and/or tenant/owners to control sensors/actuators 102 as well as define classifications and/or rules for the sensors/actuators 102. The cloud service 118 may create and manage credentials for access control such as ones used in readers, cards, door locks, and the like.

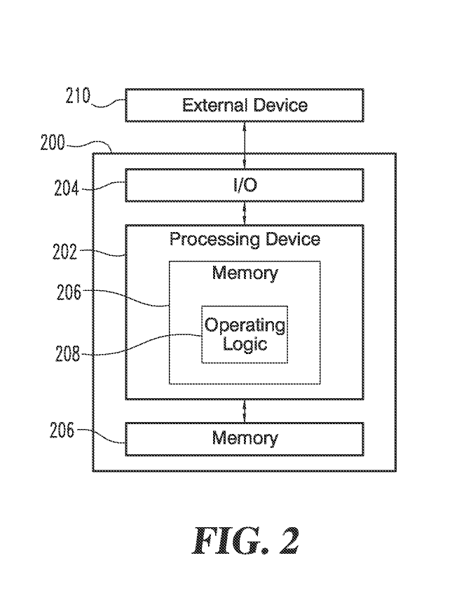

FIG. 2 is a schematic diagram of a computer 200. The computer 200 is one example of a control device or controller, computer or server, server/database, and/or mobile device which may be utilized in connection with the master control device 104, computer or server 120, and the server/database 122, and/or mobile device 107 shown in FIG. 1. Computer 200 includes a processing device 202, an input/output device 204, memory 206, and operating logic 208. Furthermore, computer 200 communicates with one or more external devices 210.

The input/output device 204 may be any type of device that allows the computer 200 to communicate with the external device 210. For example, the input/output device 204 may be a transceiver (e.g., WIFI, NFC, Bluetooth), network adapter, network card, interface, or a port (e.g., a USB port, serial port, parallel port, an analog port, a digital port, VGA, DVI, HDMI, FireWire, CAT 5, or any other type of port or interface). The input/output device 204 may be comprised of hardware, software, firmware, and/or state machines. It is contemplated that the input/output device 204 may include more than one transceiver, network adapter, network card, or port.

The external device 210 may be any type of device that allows data to be inputted to or outputted from the computer 200. For example, the external device 210 may be a master control device, transceiver, a. mobile device (e.g., a smartphone), an accessory, a reader device, equipment, a handheld computer, a diagnostic tool, a controller, a computer, a server, a processing system, a sensor, a printer, a display, an alarm, an illuminated indicator such as a status indicator, a keyboard, a mouse, or a touch screen display. Furthermore, it is contemplated that the external device 210 may be integrated into the computer 200. For example, the computer 200 may be a mobile phone, controller, a handheld diagnostic tool, a smartphone, a laptop computer, or a tablet computer in which case the display would be an external device 210, but the display is integrated with the computer 200 as one unit, which is consistent with the general design of mobile phones, handheld diagnostic tools, smartphones, laptop computers, tablet computers, and the like. It is further contemplated that there may be more than one external device in communication with the computer 200. Another computer is one example of an external device 210.

Processing device 202 can be a programmable type, a dedicated, hardwired state machine; or a combination of these; and it can further include multiple processors, Arithmetic-Logic Units (ALUs), Central Processing Units (CPUs), Digital Signal Processors (DSPs), or the like. Processing devices 202 with multiple processing units may utilize distributed, pipelined, and/or parallel processing. Processing device 202 may be dedicated to performance of just the operations described herein or may be utilized in one or more additional applications. In the depicted form, processing device 202 is of a programmable variety that executes algorithms and processes data in accordance with operating logic 208 as defined by programming instructions (such as software or firmware) stored in memory 206. Alternatively or additionally, operating logic 208 for processing device 202 is at least partially defined by hardwired logic or other hardware. Processing device 202 can be comprised of one or more components of any type suitable to process the signals received from input/output device 204 or elsewhere, and provide desired output signals. Such components may include digital circuitry, analog circuitry, or a combination of both.

Memory 206 may be of one or more types, such as a solid-state variety, electromagnetic variety, optical variety, or a combination of these forms. Furthermore, memory 206 can be volatile, nonvolatile, or a mixture of these types, and some or all of memory 206 can be of a portable variety, such as a disk, tape, memory stick, cartridge, or the like. In addition, memory 206 can store data that is manipulated by the operating logic 208 of processing device 202, such as data representative of signals received from and/or sent to input/output device 204 in addition to or in lieu of storing programming instructions defining operating logic 208, just to name one example. As shown in FIG. 2, memory 206 may be included with processing device 202 and/or coupled to the processing device 202.

As described above, the system 100 includes one or more modules 108, 110, 112, 114, 116 that may be part of one or more processing devices 202 (as part of computer/server 120, server/database 122 in the cloud service 118, or mobile device 107) or be standalone computing devices. A module may be implemented in operating logic 208 as operations by software, hardware, artificial intelligence, fuzzy logic, or any combination thereof, or at least partially performed by a user or operator. In certain embodiments, modules represent software elements as a computer program encoded on a computer readable medium, wherein a computer performs the described operations. when executing the computer program. A module may be a single device, distributed across devices, and/or a module may be grouped in whole or in part with other modules or devices. The operations of any module may be performed wholly or partially in hardware/software or by other module. The presented Organization of the modules is exemplary only, and other organizations, configurations and arrangements are contemplated.

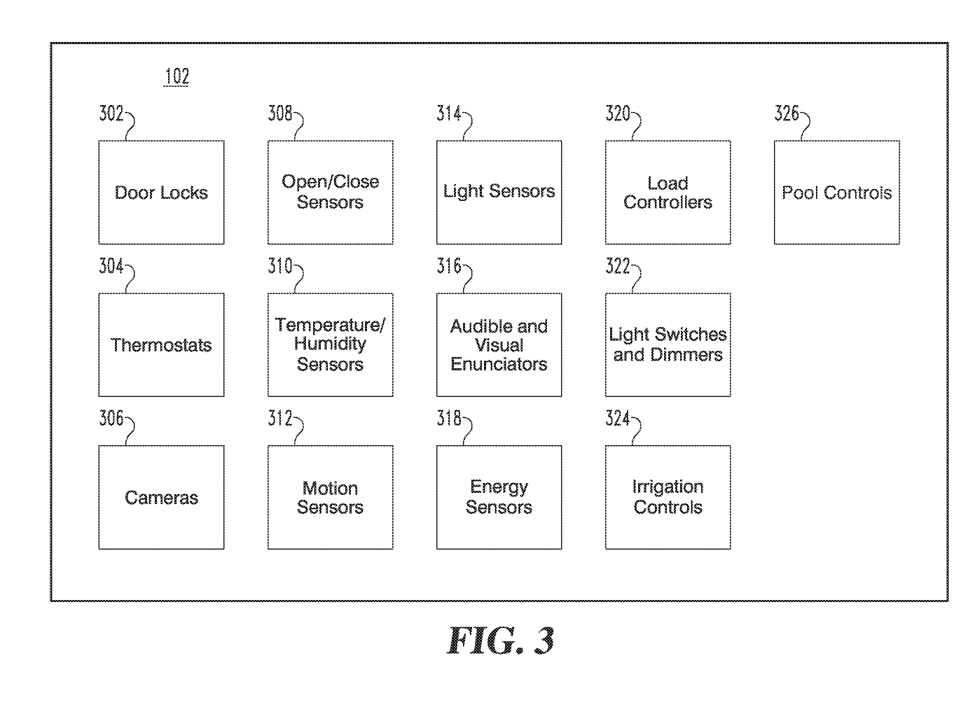

FIG. 3 illustrates the various types sensors/actuators 102, including but not limited, to, door locks 302, thermostats 304, cameras 306. open/close sensors 308, temperature/humidity sensors 310, motion sensors 311 light sensors 314, audible and visual enunciators 316, energy sensors 318, load controllers 320, light switches and dimmers 322, irrigation controls 324, pool controls 326, or any other suitable sensor or actuator. It is contemplated that other sensors and/or actuators 102 may be used in the system 100.

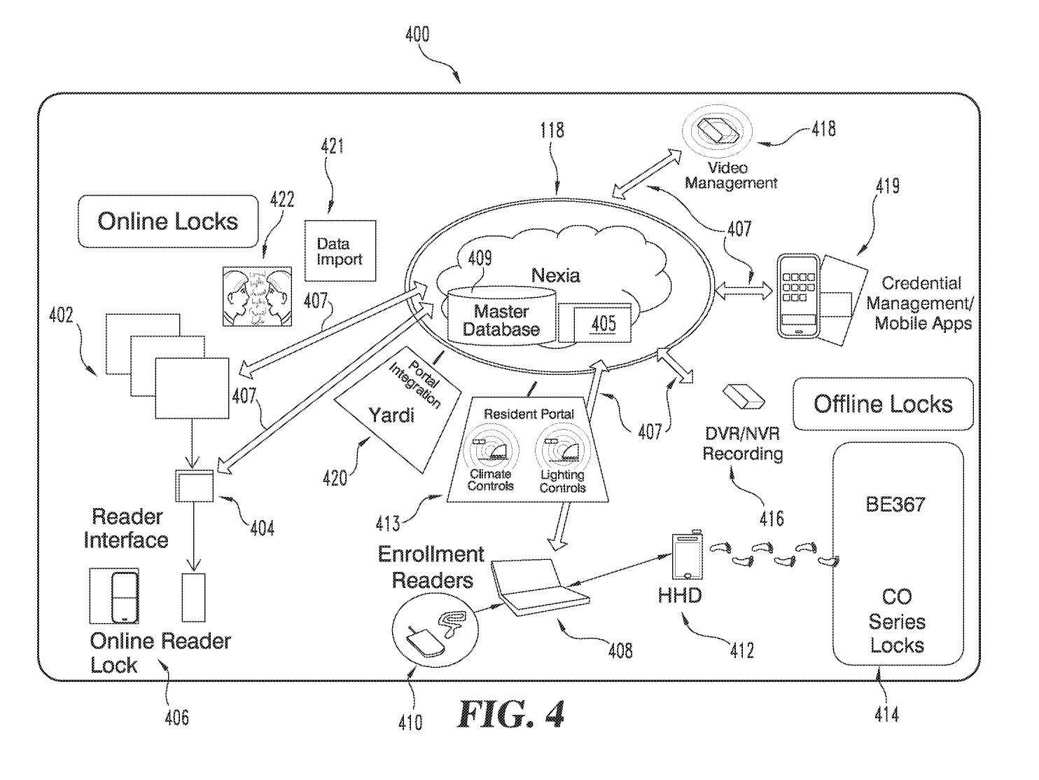

FIG. 4 illustrates an example of a system 400, which is generally based on the system 100. Generally, the building 101 includes a master control device 104 such as a controller 402, such as one manufactured under the BRIGHT BLUE™, that communicates with a reader interface 404. The controller 402 controls one or tore readers or door locks 406 by ensuring that the readers or door locks 406 are using the correct access rights or credentials, among other things. The readers or door locks 406 are examples of online locks, which are connected to the controller 402 via a network.

When a user uses a reader/door lock 406, the reader/door lock 406 may have certain credentials stored inside or the reader/door lock 406 may communicate with the reader interface 404 to verify whether the individual can gain access to the area. The reader interface 404 may then communicate with the controller 402 to confirm access rights. The controller 402 may be configured over a communication channel 407 such as the Internet. The communication channel 407 may be any appropriate or supported type of communication channel such as those identified with respect to communication channel 106.

In one example, there may be portal integration 405 in which the controller 402 no longer is present in the building 101, but instead resides as part of the cloud service 118 via a communication channel 407 such as the Internet using, e.g., HTTPS. Moreover, access may be verified in real-time via the controller 405, which is part of the cloud service 118. In this way, the reader interface 404 communicates with the controller 405 at the cloud service 118 to configure credentials and/or verify access rights. In addition, a site manager may configure the credentials or individuals that may access certain reader/door locks 406 using the cloud service 118 as the credentials, access rights, and/or other information may be stored in the master database 409 in the cloud service 118.

A computer 408 may communicate with the cloud service 118 through a communication channel 407 such as the Internet using HTTPS or any other suitable protocol. The computer 408 may facilitate the enrollment of credentials such as downloading credentials and transferring them to an enrollment reader 410 or handheld device 412. The enrollment reader 410 may receive credentials from the computer 408 and enroll the credentials onto cards and the like for use with online locks and offline locks 414, for example. The handheld device 412 may be used to program credentials into the offline locks 414.

It is contemplated that the functionality provided by the computer 408, enrollment reader 410, and/or handheld device 412 may be provided by the cloud service 118 and delivered to the different devices (e.g., readers, mobile phones, and other devices that utilize credentials) via a communication channel 407 such as the Internet. For example, climate controls and/or lighting controls 413 for a resident or tenant/owner may be accessed through a portal or integrated into the cloud service 118 such that the resident or tenant/owner may access and adjust the settings for the sensors/actuators 102 from any computing device that has a supported communication channel such as an Internet connection.

The system 400 may include the ability for users to control DVR/NVR recording 416 at their home through the cloud service 118. The system 400 may also include the ability for users to control video recording and/or management 418 at their homes or offices through the cloud service 118.

In addition, the system 400 may include a mobile device with one or more credential management and mobile applications 419 utilizing the cloud service 118 in which the mobile device receives one or more credentials from the cloud service 118.

The system 400 may also include property management software system portal integration 420 into the cloud service 118. One example of a property management software system is Yardi, which allows property managers to manage resident information, billing, maintenance (e.g., work orders), and the like. As shown in FIG. 4, the property management software system 420 is part of the cloud service 118 allowing tenant information to be stored in the master database 409 to be shared across systems such as portal integration 405, climate controls and/or lighting controls 413, DVR/NYR recording 416, video recording and/or management 418, and/or credential management and mobile applications 419.

The system 400 may also include the ability to import data 421 from controller 402 into the cloud service 118. In addition, the system 400 may provide multi-language support 422 of devices, such as readers 406, in the field by the cloud service 118. Furthermore, it is contemplated that the cloud service 118 may be a service such as Nexia Home Intelligence.

One aspect of the present application includes a housing unit control system, comprising: a property manager module to manage settings of sensors/actuators in a plurality of housing units, wherein the housing units are classified; a tenant/owner control module to manage the settings for the sensors/actuators in at least one of the housing units; and a controller to communicate the settings from at least one of the modules to at least one of the sensors/actuators.

Features of the aspect may include: wherein the housing units are in a hotel; wherein the housing units are in an apartment building; wherein the housing units are in a condominium complex; a cloud service that includes the property manager module and the tenant/owner module; a classification module that maintains classifications of the housing units, wherein each classification defines rules for managing the settings; a rules module to manage the rules for each of the classifications; a transfer module to transfer control of the sensors/actuators when one of the housing units becomes unoccupied; wherein the sensors/actuators include at least one of a door lock, a thermostat, a camera, an open/close sensor, a temperature/humidity sensor, a motion sensor, a light sensor, an audible and visual enunciator, an energy sensor, a load controller, a light switch and dimmer, an irrigation control, and a pool control.

Another aspect of the present application includes a method for controlling housing units, comprising: classifying a housing unit into a classification that defines rules for controlling settings for sensors/actuators; managing, with a first module, the settings of the sensors/actuators according to a first hierarchy of rules; and managing, with a second module, the settings according to a second hierarchy of rules.

Features of the aspect may include: wherein the classification is based on occupancy; wherein at least one of the first module and the second module are part of a cloud service; wherein the first hierarchy of rules is more restrictive than the second hierarchy of rules; transferring control of the settings from the second module to the first module when the housing unit is unoccupied.

Yet another aspect of the present application includes a method for controlling a building, comprising: assigning a space within a building a control classification; configuring rules for the classification to establish the control of a plurality of sensors/actuators; and configuring settings on the sensors/actuators in accordance with the rules.

Features of the aspect may include: wherein the space is a housing unit; wherein the classification is based on occupancy; wherein the space is a common area.

Another aspect of the present application may include an apparatus for controlling buildings, comprising: means for classifying a space in a building into a control classification; means for configuring rules for the classification to establish control of a plurality of sensors/actuators; and means for configuring settings on the sensors/actuators in accordance with the rules.

Yet another aspect of the present application may include an apparatus for controlling buildings, comprising: a master control device to control a plurality of sensors/actuators in a space in a building; a classification module to classify the space; a property manager module to manage settings of sensors/actuators; and a tenant/owner module to manage the settings for the sensors/actuators.

Features of the aspect of the present application may include: a transfer module to transfer control of the sensors/actuators when the space is an unoccupied housing unit; a rules module to establish rules for the classification, wherein the rules restrict control of the sensors/actuators; wherein at least one of the master control device, the classification module, the property manager module, and the tenant/owner module are part of a cloud service.

Another aspect of the present application includes a system, comprising: a classification module configured to classify a plurality of spaces in a building into one or more classifications, wherein each of the classifications define rules for managing a plurality of settings of a plurality of devices in the plurality of spaces; a property manager module to manage the settings of a first portion of the devices in the building, a tenant/owner module to manage the settings of a second portion of the devices in the building, wherein at least one of the plurality of devices is in the first portion and in the second portion; and a controller to communicate the settings from at least one of the property manager module and the tenant/owner module to at least one of the devices according to the rules defined by the classifications.

Features of the aspect of the present application may includes: wherein the spaces are in at least one of a hotel, an apartment building, a condominium complex, a dormitory, an assisted living facility, a nursing home, a retirement home, a commercial office building, and a storage garage; a computer that includes the classification module, the property manager module, and the tenant/owner module, wherein the computer is remotely located from the building; wherein at least one of the classifications is a common area and another one of the classifications is a housing unit; a rules module to manage the rules for each of the classifications, wherein the rules each of the classifications include at least one difference from one another; a transfer module configured to transfer control of the devices from the tenant/owner module to the property manager module when one of the housing units becomes unoccupied; wherein the devices include at least one of a door lock, a thermostat, a camera, an opera/close sensor, a temperature/humidity sensor, a motion sensor, a light sensor, an audible and visual enunciator, an energy sensor, a load controller, a light switch, a dimmer, an irrigation control, and a pool control; at least one of a smartphone and a tablet computer configured to communicate with the controller to adjust the settings of at least one of the devices; wherein the property manager module is configured to set boundaries for at least one of the devices controllable by the tenant/owner module.

Yet another aspect of the present application includes a method, comprising: classifying a plurality of spaces in a building into one or more classifications, wherein each of the classifications defines a first hierarchy of rules and a second hierarchy of rules to manage a plurality of settings of a plurality of devices in the plurality of spaces; managing the settings of a portion of the devices in the building according to the first hierarchy of rules; managing the settings of a portion of the devices in the building according to the second hierarchy of rules; and controlling, with a controller, the settings of at least one of the devices according to one of the first hierarchy of rules and the second hierarchy of rules.

Features of the aspect of the present application may include: managing the rules for each of the classifications, wherein the rules for each of the classifications include at least one difference from one another; transferring, with a transfer module, control of the devices from a tenant/owner account to a property manager account when one of the housing units becomes unoccupied; adjusting the settings of at least one of the devices with one of a smartphone and a tablet computer; establishing, with the first hierarchy of rules, boundaries for the second hierarchy of rules for at least one of the devices.

Another aspect of the present application includes a method, comprising: assigning a space within a building a control classification; establishing a first hierarchy of rules for managing settings of a device in the space, wherein the first hierarchy of rules are associated with a property manager account; establishing a second hierarchy of rules for managing settings of the device in the space, wherein the second hierarchy of rules arc associated with a tenant/owner account; and configuring a setting on the device in accordance with the rules.

Features of the aspect of the present application may include: wherein the space is a housing unit; wherein the first hierarchy of rules establishes boundaries for the second hierarchy of rules.

Another aspect of the present application includes a system, comprising: a master control device to control a plurality of devices in a plurality of housing units in a building; a classification module configured to assign classifications to the housing units; a rules module configured to establish a first hierarchy of rules and a second hierarchy of rules for each the housing units; a property manager module configured to manage settings of the devices according to the first hierarchy of rules by communicating with the master control device; and a tenant/owner module configured to manage the settings of the devices according to the second hierarchy of rules by communicating with the master control device.

Features of the aspect of the present application may include: a server configured to provide a cloud service, wherein the cloud service includes at least one of the master control device, the classification module, the rules module, the property manager module, and the tenant/owner module; at least one of a smartphone and a tablet computer configured to change at least one of the settings of the one of the devices.

The present invention may be implemented on any type of computer and using a variety of different software. For example, the present application may be implemented using Microsoft Excel, Microsoft Access, Microsoft SQL Server, any of Oracle's database systems, MySQL, custom software modules, custom databases, any other appropriate software or database, or any combination thereof When the computer or storage system is configured as a database, it is contemplated that the database may be any type of database, such as relational, hierarchical, object-oriented, and/or the like.

A computer readable medium may refer to any tangible storage and/or transmission medium that participate in providing instructions to a processing device for execution. Such a medium may take many forms, including but not limited to non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A system, comprising:
a classification module configured to classify a plurality of spaces in a building into one or more classifications, wherein each of the classifications define rules for managing a plurality of settings of a plurality of devices in the plurality of spaces;
a property manager module to manage the settings of a first, portion of the devices in the building,
a tenant/owner module to manage the settings of a second portion of the devices in the building, wherein at least one of the plurality of devices is in the first portion and in the second portion; and
a controller to communicate the settings from at least one of the property manager module and the tenant/owner module to at least one of the devices according to the rules defined by the classifications.

2. The system of claim 1, wherein the spaces are in at least one of a hotel, an apartment building, a condominium complex, a dormitory, an assisted living facility, a nursing home, a retirement home, a commercial office building, and a storage garage.

3. The system of claim 1, further comprising:
a computer that includes the classification module, the property manager module, and the tenant/owner module, wherein the computer is remotely located from the building.

4. The system of claim 1, wherein at least one of the classifications is a common area and another one of the classifications is a housing unit.

5. The system of claim 1, further comprising:
a rules module to manage the rules for each of the classifications, wherein the rules for each of the classifications include at least one difference from one another.

6. The system of claim 1, further comprising:
a transfer module configured to transfer control of the devices from the tenant/owner module to the property manager module when one of the housing units becomes unoccupied.

7. The system of claim 1, wherein the devices include at least one of a door lock, a thermostat, a camera, an open/close sensor, a temperature/humidity sensor, a motion sensor, a light sensor, an audible and visual enunciator, an energy sensor, a load controller, a light switch, a dimmer, an irrigation control, and a pool control.

8. The system of claim 1, further comprising:
at least one of a smartphone and a tablet computer configured to communicate with the controller to adjust the settings of at least one of the devices.

9. The system of claim 1, wherein the property manager module is configured to set boundaries for at least one of the devices controllable by the tenant/owner module.

10. A method, comprising:
classifying a plurality of spaces in a building into one or more classifications, wherein each of the classifications defines a first hierarchy of rules and a second hierarchy of rules to manage a plurality of settings or a plurality of devices in the plurality of spices;
managing the settings of a portion of the devices in the building according to the first hierarchy of rules;
managing the settings of a portion of the devices in the building according to the second hierarchy of rules; and
controlling, with a controller, the settings of at least one of the devices according to one of the first hierarchy of rules and the second hierarchy of rules.

11. The method of claim 10, further comprising:
managing the rules for each of the classifications, wherein the rules for each of the classifications include at least one difference from one another.

12. The method of claim 10, further comprising:
transferring, with a transfer module, control of the devices from a tenant/owner account to a property manager account when one of the housing units becomes unoccupied.

13. The method of claim 10, further comprising:
adjusting the settings of at least one of the devices with one of a smartphone and a tablet computer.

14. The method of claim 10, further comprising:
establishing, with the first hierarchy of rules, boundaries for the second hierarchy of rules for at least one of the devices.

15. A method, comprising:
assigning a space within a building a control classification;
establishing a first hierarchy of rules for managing settings of a device in the space, wherein the first hierarchy of rules are associated with a property manager account;
establishing a second hierarchy of rules for managing settings of the device in the space, wherein the second hierarchy of rules are associated with a tenant owner account; and
configuring a setting on the device in accordance with the rules.

16. The method of claim 15, wherein the space is a housing unit.

17. The method of claim 16, wherein the first hierarchy of rules establishes boundaries for the second hierarchy of rules.

18. A system, comprising:
a master control device to control a plurality of devices in a plurality of housing units in ₄. building;
a classification module configured to assign classifications to the housing units;
a rules module configured to establish a first hierarchy of rules and a second hierarchy of rules for each the housing units;
a property manager module configured to manage settings of the devices according to the first hierarchy of rules by communicating with the master control device; and
a tenant/owner module configured to manage the settings of the devices according to the second hierarchy of rules by communicating with the master control device.

19. The system of claim 18, further comprising:
a server configured to provide a cloud service, wherein the cloud service includes at least one of the master control device, the classification module, the rules module, the property manager module, and the tenant/owner module.

20. The system of claim 18, further comprising:
at least one of a smartphone and a tablet computer configured to change at least one of the settings of the one of the devices.
